(19) United States
(12) Patent Application Publication
(10) Pub. No.: US 2014/0157290 A1
(43) Pub. Date: Jun. 5, 2014

(54) Method, system, and device for switching between network applications, and computer storage medium

(71) Applicant: TENCENT TECHNOLOGY (SHENZHEN) COMPANY LIMITED, Shenzhen (CN)

(72) Inventors: Yang Li, Shenzhen (CN); Zhanwei Wang, Shenzhen (CN); Junjie Zheng, Shenzhen (CN)

(21) Appl. No.: 14/132,402

(22) Filed: Dec. 18, 2013

Related U.S. Application Data
(63) Continuation of application No. PCT/CN2012/087200, filed on Dec. 21, 2012.

(30) Foreign Application Priority Data
Jan. 13, 2012 (CN) 2012100108341

(51) Int. Cl. G06F 9/54; G06F 3/0484

(52) U.S. Cl. CPC G06F 9/541; G06F 3/04845
USPC 719/328

(57) ABSTRACT

A method, system, and device for switching between network applications, and a computer storage medium are described. The method includes acquiring an interface trigger instruction, and searching for a network application identifier and contact information according to the interface trigger instruction; locating a network application server according to network application information, and acquiring interface information of a contact in the network application from the network application server according to the contact information; and displaying the interface information. The method can simplify the switching between various network applications, and realize one-key switching.

### CROSS REFERENCE TO RELATED APPLICATIONS

This is a continuation application of International Patent Application No.: PCT/CN2012/087200, filed on Dec. 21, 2012, which claims priority to Chinese Patent Application No.: 201210010834.1, filed on Jan. 13, 2012, the disclosure of which is incorporated by reference herein in its entirety.

### TECHNICAL FIELD

The disclosure relates to the field of Internet technology, particularly to a method and system for switching between network applications, and specifically to a method, system, device for switching between network applications in communication terminals including desktop computers, handheld computers, mobile phones, tablet computers, etc., and to a computer-readable storage medium.

### BACKGROUND

With the rapid development of Internet technology, requirements of users on Internet services are increasing higher and thus a series of network applications (such as Instant Messenger (IM), blogs and micro-blogs) are developed.

Generally, a user may use a plurality of network applications simultaneously, for example, when chatting with a friend through an IM tool, the user also opens other network applications of the friend, such as a blog and a micro-blog of the friend.

Various network applications above are completely independent with each other without integration. Therefore, the user cannot use two or more network applications simultaneously in a same program or on a same interface. For example, when a user is chatting with a friend with an IM tool, to access a blog or a space of the friend, the user has to start a browser to enter a page corresponding to the blog or the space of the friend; likewise, when the user is browsing the space or the blog of the friend, to chat with the friend, the user has to start an IM tool. Such frequent operations bring about bad user experience.

### SUMMARY

In view of this, the embodiments of the disclosure is to provide a method, system and device for switching between network applications, and a computer storage medium, specifically a method, system, device for switching between network applications in communication terminals including desktop computers, handheld computers, mobile phones, tablet computers, etc. so as to simplify the switching between various network applications, and realize one-key switching.

An embodiment of the disclosure provides a method for switching between network applications, which includes:

acquiring an interface trigger instruction, and search for a network application identifier and contact information according to the interface trigger instruction;

sending the network application identifier and the contact information acquired through the searching to a proxy server, and receiving, from the proxy server, interface information of a contact corresponding to the contact information in a network application, and displaying the interface information.

An embodiment of the disclosure further provides another method for switching between network applications, which includes:

acquiring a network application identifier and contact information provided by a client device, locate a network application server according to the network application identifier, and acquiring from the network application server, interface information of a contact in a network application according to the contact information; and

sending the acquired interface information to the client device.

An embodiment of the disclosure further provides a client device, which includes a query module and an information processing module.

The query module is configured to acquire an interface trigger instruction, and to search for a network application identifier and contact information according to the interface trigger instruction.

The information processing module is configured to send the network application identifier and the contact information acquired through the searching to a proxy server, and to receive, from the proxy server, interface information of a contact corresponding to the contact information in a network application, and to display the interface information.

An embodiment of the disclosure further provides a proxy server, which includes a locating module and an information sending module.

A locating module is configured to acquire a network application identifier and contact information provided by a client device, to locate a network application server according to the network application identifier, and to acquire from the network application server, interface information of a contact in a network application according to the contact information.

The information sending module is configured to send the acquired interface information to the client device.

An embodiment of the disclosure further provides a system for switching between network applications, which includes a client device, a proxy server and a network application server.

The client device is configured to acquire an interface trigger instruction, to search for a network application identifier and contact information according to the interface trigger instruction, and to send the network application identifier and the contact information acquired through the searching to the proxy server.

The proxy server is configured to locate a network application server according to the network application identifier provided by the client device, to acquired, from the network application server, interface information of a contact in a network application according to the contact information provided by the client device, and to send the acquired interface information to the client device.

The client device is further configured to display the interface information provided by the proxy server.

The network application server is configured to provide the interface information to the proxy server.

An embodiment of the disclosure further provides a non-transitory computer-readable storage medium storing a set of computer executable instructions, when executed, cause at least one processor to perform the step comprising:

acquiring an interface trigger instruction, and searching for a network application identifier and contact information according to the interface trigger instruction; and

sending the network application identifier and the contact information acquired through the searching to a proxy server, receiving, from the proxy server, interface information of a contact corresponding to the contact information in a network application, and displaying the interface information.

An embodiment of the disclosure further provides a non-transitory computer-readable storage medium storing a set of computer executable instructions, when executed, cause at least one processor to perform the steps comprising:

acquiring a network application identifier and contact information provided by a client device, locating a network application server according to the network application identifier, and acquiring, from the network application server, interface information of a contact in a network application according to the contact information; and

sending the acquired interface information to the client device.

According to a method and system for switching between network applications, and a computer storage medium of the embodiments of the disclosure, a client device integrates various network applications and can send network application information and contact information many times according to user demands; a proxy server obtains interface information of a contact in a network application according to the network application information and the contact information sent by the client device and returns the interface information to the client device to be displayed. In this way, when a user who is using a certain network application in the client device wants to start other network applications, the user only needs to trigger, with one key on an interface of the client device, the client device to send corresponding network application information and contact information from the client device, then a corresponding interface can be viewed on the client device, thus simplifying the switching between various network applications and improving user experience.

### BRIEF DESCRIPTION OF THE DRAWINGS

FIG. 1 illustrates a flowchart of a method for switching between network applications according to an embodiment of the disclosure;

FIG. 2 illustrates a structural diagram of a system for switching between network applications according to an embodiment of the disclosure;

FIG. 3 illustrates a flowchart of switching between network applications, implemented by a client device according to an embodiment of the disclosure;

FIG. 4 illustrates a flowchart of switching between network applications, implemented by a proxy server side according to an embodiment of the disclosure;

FIG. 5 illustrates a structural diagram of a client device according to an embodiment of the disclosure; and

FIG. 6 illustrates a structural diagram of a proxy server according to an embodiment of the disclosure.

### DETAILED DESCRIPTION

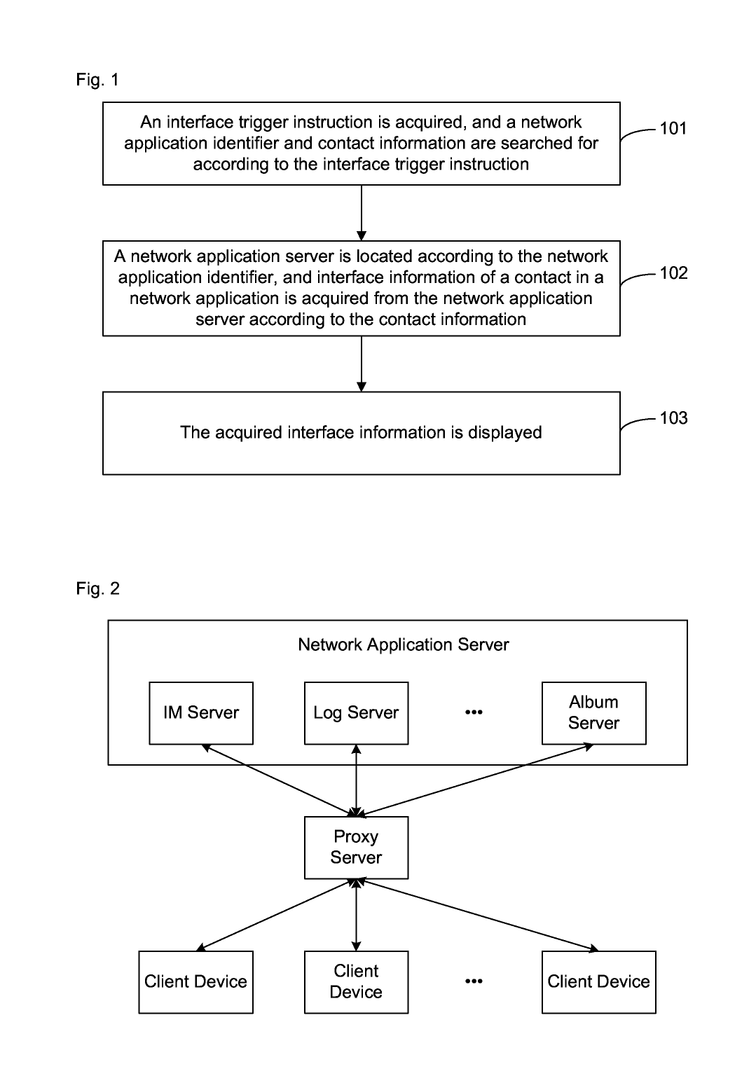

A method or switching between network applications according to an embodiment of the disclosure, as shown in FIG. 1, includes the following steps:

In step 101, an interface trigger instruction is acquired, and a network application identifier and contact information are searched for according to the interface trigger instruction.

Various network applications are integrated in a client device provided by an embodiment of the disclosure. Therefore, at least one network application identifier is stored in the client device and a corresponding network application server can be located according to the network application identifier. The network application identifier may be, but is not limited to, a network application icon, a link, etc.

In addition, a user may store information of at least one contact in the client device. Preferably, the information of the contact may be a contact identifier, such as. a number, a name, etc.

Based on the above, the user may associate a certain contact with a certain network application by means of one click on an interface of the client device, so as to trigger the client device to generate a corresponding interface trigger instruction. The interface trigger instruction includes two parts, one is used to instruct acquiring contact information and the other is used to instruct acquiring network application information. According to the interface trigger instruction, the client device can acquire corresponding network application information and contact information directly through search.

There are various methods for associating a contact with a network application by means of one click. For example, in a tablet computer application:

an avatar of a contact and an icon of a network application may be displayed on the same interface of the client device; when a user wants to access a certain contact interface of a certain network application, the user only needs to click the avatar of the contact, drag the avatar to the area covered by the icon of the network application and then release the avatar; an interface trigger instruction is generated in the background as soon as the avatar is released;

the avatars of all contacts may be displayed on an interface of the client device; when the user wants to perform related operations relating to a certain contact, the user only needs to position the mouse or a touch object over the avatar of the contact, wait until the icons of a plurality of network applications are displayed in a floating window and click the icon of a network application as needed; an interface trigger instruction is generated in the background as soon as the icon is clicked;

further, each time when the avatar of the contact is clicked, the contact may be associated with a network application next to the current one among a plurality of network applications arranged in turn.

It should be noted that the one click methods are not limited to the three methods above, and any method that can associate a contact with a network application by means of one click and trigger the background to generate an interface trigger instruction is applicable to the embodiments of the disclosure.

In step 102, a network application server is located according to the network application identifier, and interface information of a contact in a network application is acquired from the network application server according to the contact information.

The client device sends the network application identifier and the contact information to a proxy server. The proxy server needs to locate a corresponding network application server first according to the network application identifier, and then acquires, from the located network application server, interface information of the contact in the network application according to the contact information.

Specifically, the contact selected by the user is unique, but there may be a plurality of network application servers corresponding to an associated network application, such as a space integrates functions including log and albums, etc., so a log server and an album server may be located. Specifically, a mapping relation between network application identifiers and network application server information (e.g. an Internet Protocol (IP) address of a network application server) may be preset and stored in the proxy server. The proxy server can determine network application server information according to a network application identifier, and then access a corresponding network application server according to the network application server information.

In step 103, the acquired interface information is displayed.

Through the method above, a user can view an interface of an expected contact in a certain network application on a client device interface by means of only one click. For example, when a user chatting with contact A wants to browse a blog of contact A, the user can make it without quitting the chat by clicking the avatar of contact A directly, dragging the avatar to the blog icon of the interface and then releasing the avatar. It should be noted that interfaces of a plurality of network applications are allowed to be present in the client device provided by the embodiments of the disclosure. A series of subsequent operations, including generating an interface trigger instruction, searching for a network application identifier and contact information, locating a network application server, and acquiring and returning the interface information, are executed in the background, which are transparent for the user.

To realize the one-key switching scheme above, an embodiment of the disclosure provides a system. As shown in FIG. 2, the system includes a client device, a proxy server and a network application server.

The client device is configured to acquire an interface trigger instruction, to search for a network application identifier and contact information according to the interface trigger instruction, and to send the network application identifier and the contact information acquired through the searching to the proxy server.

The proxy server is configured to locate a network application server according to the network application identifier provided by the client device, to acquire, from the network application server, interface information of a contact in a network application according to the contact information provided by the client device, and to send the acquired interface information to the client device.

Accordingly, the client device is further configured to display the interface information provided by the proxy server. The network application server may include IM server, log server, album server, etc.

The network application server is configured to provide the interface information to the proxy server.

In order to obtain the interface trigger instruction, the client device associates the contact with the network application by means of one click, and triggers the background to generate a corresponding interface trigger instruction. In the client device provided by the embodiment of the disclosure, information of at least one contact and at least one network application identifier are stored.

Preferably, in order to associate the contact with the network application by means of one click, the client device is further configured to:

click an avatar of the contact, drag the avatar to an area covered by an icon of the network application, and then release the avatar; or

associate the contact with a network application next to a current one among a plurality of network applications arranged in turn when the avatar of the contact is clicked each time; or

position a mouse or a touch object over the avatar of the contact, and click an icon of a network application as needed when icons of a plurality of network applications are displayed in a floating window.

Preferably, the proxy server is further configured to preset and store a mapping relation between network application identifiers and network application server information.

Preferably, the proxy server is further configured to determine network application server information according to the network application identifier and the mapping relation, and to locate a corresponding network application server according to the determined network application server information.

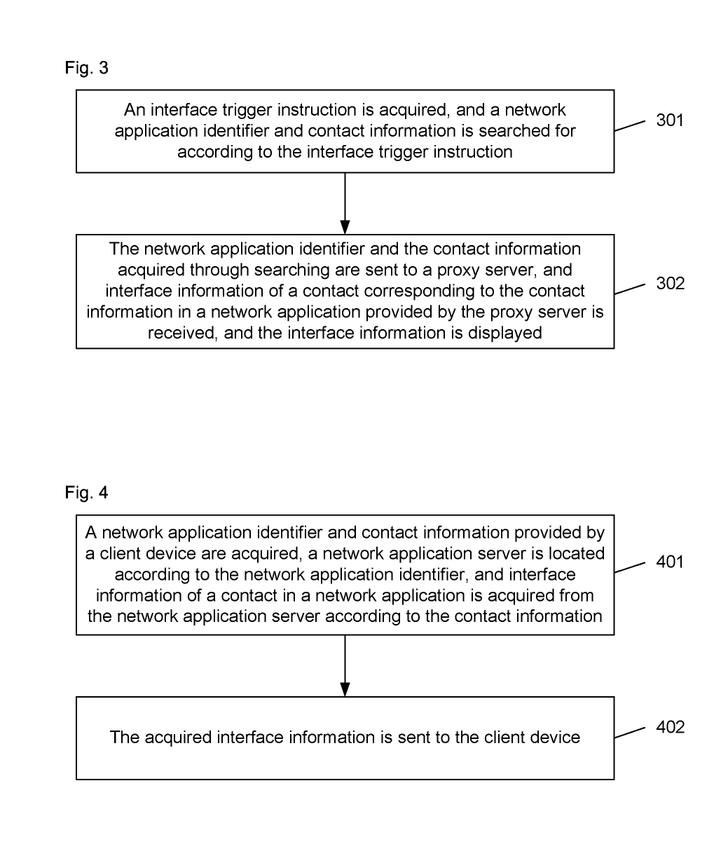

Based on the embodiment as shown in FIG. 1, an embodiment of the disclosure further provides a process for switching between network applications, implemented by a client device. As shown in FIG. 3, the process mainly includes the following steps:

In step 301, an interface trigger instruction is acquired, and a network application identifier and contact information is searched for according to the interface trigger instruction.

Acquiring the interface trigger instruction includes:

associating a contact with a network application by means of one click and triggering generation of a corresponding interface trigger instruction.

The associating a contact with a network application by means of one click includes:

click an avatar of the contact, drag the avatar to an area covered by an icon of the network application, and then release the avatar; or

associate the contact with a network application next to a current one among a plurality of network applications arranged in turn when the avatar of the contact is clicked each time; or

position a mouse or a touch object over the avatar of the contact, and click on the icon of a network application as needed when icons of a plurality of network applications are displayed in a floating window.

In step 302, the network application identifier and the contact information acquired through searching are sent to a proxy server, and interface information of a contact corresponding to the contact information in a network application provided by the proxy server is received, and the interface information is displayed.

Based on the embodiment as shown in FIG. 1, an embodiment of the disclosure further provides a process for switching between network applications, implemented by a proxy server. As shown in FIG. 4, the process mainly includes the following steps:

In step 401, a network application identifier and contact information provided by a client device are acquired, a network application server is located according to the network application identifier, and interface information of a contact in a network application is acquired from the network application server according to the contact information;

In step 402, the acquired interface information is sent to the client device.

The process further includes presetting and storing a mapping relation between network application identifiers and network application server information in the proxy server.

Accordingly, locating the network application server according to the network application identifier includes:

determining network application server information according to the network application identifier and the mapping relation, and locate a corresponding network application server according to the determined network application server information.

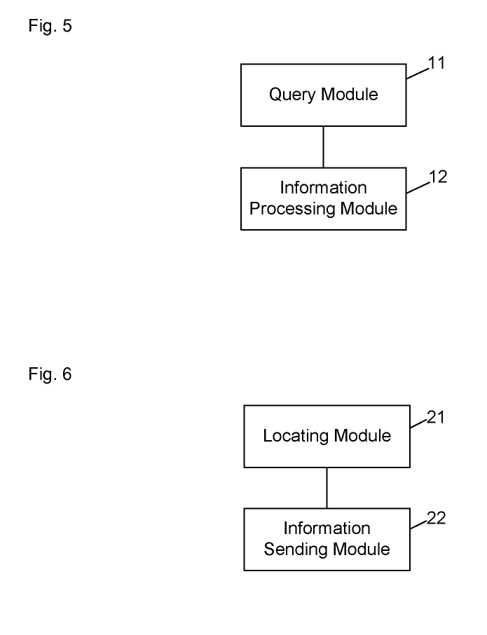

Corresponding to the switching process as shown in FIG. 3, an embodiment of the disclosure further provides a client device. As shown in FIG. 5, the client device includes a query module 11 and an information processing module 12.

The query module 11 is configured to acquire an interface trigger instruction, and to search for a network application identifier and contact information according to the interface trigger instruction.

The information processing module 12 is configured to send the network application identifier and the contact information acquired through the searching to a proxy server, and to receive, from the proxy server, interface information of a contact corresponding to the contact information in a network application, and to display the interface information.

Preferably, the query module 11 is further configured to associate a contact with a network application by means of one click and to trigger generation of a corresponding interface trigger instruction.

Corresponding to the switching process as shown in FIG. 4, an embodiment of the disclosure further provides a proxy server. As shown in FIG. 6, the proxy server includes a locating module 21 and an information sending module 22.

The locating module 21 is configured to acquire a network application identifier and contact information provided by a client device, to locate a network application server according to the network application identifier, and to acquire, from the network application server, interface information of a contact in a network application according to the contact information.

The information sending module 22 is configured to send the acquired interface information to the client device.

Preferably, the locating module 21 is further configured to preset and store a mapping relation between network application identifiers and network application server information.

Preferably, the locating module 21 is further configured to determine network application server information according to the network application identifier and the mapping relation, and to locate a corresponding network application server according to the determined the network application server information.

In practical application, comprehensive network applications like spaces and blogs integrate single network applications including log, albums, dynamic information, etc. A plurality of single network application servers can be mapped to according to identifiers of the comprehensive network applications. Therefore, the proxy server of the embodiment of the disclosure is further configured to preset and store a mapping relation between network application identifiers and network application server information. On this basis, the proxy server determines network application server information according to a network application identifier and the mapping relation, and locates a corresponding network application server according to the determined the network application server information.

When being implemented in the form of a software functional unit and sold or used as a separate product, the integrated modules of the embodiments of the disclosure may be stored in a computer-readable storage medium. Based on this understanding, the technical solutions of the embodiments of the disclosure essentially, or the part contributing to the prior art, may be implemented in the form of a software product. The computer software product is stored in a storage medium including a set of instructions for instructing computer equipment (such as a personal computer, a server, a network device, etc.) to execute all or a part of the method described in each embodiment of the disclosure. The above storage medium may be any medium capable of storing program codes, such as a U-disk, a mobile hard disk, a Read-Only Memory (ROM), a Random Access Memory (RAM), a magnetic disk, and an optical disk. Therefore, the embodiments of the disclosure are not limited to any specific combination of hardware and software.

Accordingly, an embodiment of the disclosure further provides a non-transitory computer-readable storage medium storing a computer program including a set of computer executable instructions. The computer program is used for executing the method for switching between network applications of the embodiment of the disclosure shown in FIG. 3.

An embodiment of the disclosure further provides a non-transitory computer-readable storage medium storing a computer program including a set of computer executable instructions. The computer program is used for executing the method for switching between network applications of the embodiment of the disclosure shown in FIG. 4.

The above are only preferred embodiments of the disclosure and are not intended to limit the scope of protection of the disclosure.

1. A method for switching between network applications, comprising:
acquiring an interface trigger instruction, and searching for a network application identifier and contact information according to the interface trigger instruction; and
sending the network application identifier and the contact information acquired through the searching to a proxy server, receiving, from the proxy server, interface information of a contact corresponding to the contact information in a network application, and displaying the interface information.

2. The method according to claim 1, wherein the acquiring the interface trigger instruction comprises:
associating a contact with a network application by means of one click, and triggering generation of a corresponding interface trigger instruction.

3. The method according to claim 2, wherein the associating the contact with the network application by means of one click comprises:
clicking an avatar of the contact, dragging the avatar to an area covered by an icon of the network application, and then releasing the avatar; or
associating the contact with a network application next to a current one among a plurality of network applications arranged in turn when the avatar of the contact is clicked each time; or
positioning a mouse or a touch object over the avatar of the contact, and clicking an icon of a network application as needed when icons of a plurality of network applications are displayed in a floating window.

4. A method for switching between network applications, comprising:
acquiring a network application identifier and contact information provided by a client device, locating a network application server according to the network application identifier, and acquiring, from the network application server, interface information of a contact in a network application according to the contact information; and
sending the acquired interface information to the client device.

5. The method according to claim 4, wherein the method further comprises: presetting and storing a mapping relationship between network application identifiers and network application server information.

6. The method according to claim 5, wherein the locating the network application server according to the network application identifier comprises:
determining network application server information according to the network application identifier and the mapping relation, and locating a corresponding network application server according to the determined network application server information.

7. A client device, comprising:
a query module configured to acquire an interface trigger instruction, and to search for a network application identifier and contact information according to the interface trigger instruction; and
an information processing module configured to send the network application identifier and the contact information acquired through the searching to a proxy server, to receive, from the proxy server, interface information of a contact corresponding to the contact information in a network application, and to display the interface information.

8. The client device according to claim 7, wherein the query module is further configured to associate a contact with a network application by means of one click and to trigger generation of a corresponding interface trigger instruction.

9. A proxy server, comprising:
a locating module configured to acquire a network application identifier and contact information provided by a client device, to locate a network application server according to the network application identifier, and to acquire, from the network application server, interface information of a contact in a network application according to the contact information; and
an information sending module configured to send the acquired interface information to the client device.

10. The proxy server according to claim 9, wherein the locating module is further configured to preset and store a mapping relation between network application identifiers and network application server information.

11. The proxy server according to claim 10, wherein the locating module is further configured to: determine network application server information according to the network application identifier and the mapping relation, and locate a corresponding network application server according to the determined network application server information.

12. A system for switching between network applications, comprising:
a client device, a proxy server and a network application server, wherein the client device is configured to acquire an interface trigger instruction, to search for a network application identifier and contact information according to the interface trigger instruction, and to send the network application identifier and the contact information acquired through the searching to the proxy server;
the proxy server is configured to locate a network application server according to the network application identifier provided by the client device, to acquire, from the network application server, interface information of a contact in a network application according to the contact information provided by the client device, and to send the acquired interface information to the client device;
the client device is further configured to display the interface information provided by the proxy server; and
the network application server is configured to provide the interface information to the proxy server.

13. The system according to claim 12, wherein the client device is further configured to associate a contact with a network application by means of one click, and to trigger a background to generate a corresponding interface trigger instruction.

14. The system according to claim 13, wherein,
the client device, to associate the contact with the network application by means of one click, is further configured to:
click an avatar of the contact, drag the avatar to an area covered by an icon of the network application, and then release the avatar; or
associate the contact with a network application next to a current one among a plurality of network applications arranged in turn when the avatar of the contact is clicked each time; or
position a mouse or a touch object over the avatar of the contact, and click an icon of a network application as needed when icons of a plurality of network applications are displayed in a floating window.

15. The system according to claim 12, wherein the proxy server is further configured to preset and store a mapping relation between network application identifiers and network application server information.

16. The system according to claim 15, wherein the proxy server is further configured to: determine network application server information according to the network application identifier and the mapping relation, and locate a corresponding network application server according to the determined network application server information.

17. (canceled)

18. (canceled)
